(19) United States
(12) Patent Application Publication
(10) Pub. No.: US 2016/0292706 A1
(43) Pub. Date: Oct. 6, 2016

(54) SYSTEMS AND METHODS FOR OFFER SELECTION AND REWARD DISTRIBUTION LEARNING

(71) Applicant: NICE-SYSTEMS LTD., Ra'anana (IL)

(72) Inventor: Leonard Michael NEWNHAM, Buckingham (GB)

(73) Assignee: NICE-SYSTEM LTD.

(21) Appl. No.: 14/829,695

(22) Filed: Aug. 19, 2015

Related U.S. Application Data
(60) Provisional application No. 62/141,273, filed on Apr. 1, 2015.

(51) Int. Cl. G06Q 30/02; G06N 99/00

(52) U.S. Cl. CPC G06Q 30/0224; G06Q 30/0239; G06Q 30/0235; G06N 99/005

(57) ABSTRACT

Methods and systems for selecting an offer from a set of offers to be served to one or more respondents. In some embodiments, for each of the offers, an expected reward distribution is obtained comprising an estimate of the distribution over time of reward received in response to the offer. Requests are received for the selection of an offer and in response to each request an offer is selected with the selection depending at least partially on the expected reward distribution. The expected reward distributions are updated in repeated update operations after the initial serving of each offer, the updating being based on an observed distribution of reward received in response to the servings of the offer. The updated expected reward distribution is then used in the next selection of an offer. Update operations may take place before a complete set of response data is received.

### CROSS REFERENCE TO RELATED APPLICATIONS

This application claims benefit from U.S. provisional patent application No. 62/141,273 filed Apr. 1, 2015, which is incorporated by reference herein in its entirety.

### FIELD OF THE INVENTION

The present invention is in the field of serving offers to individuals, for example via the internet to users of web browsers. In particular, some embodiments of the invention are in the specific field of serving targeted offers, for example offers that are aimed at a particular group of respondents. For example, a decision to serve an offer may be made automatically in real time and may utilize machine learning techniques to build and continuously improve a mathematical model used to predict which of a number of available offers an individual is most likely to respond to.

### BACKGROUND OF THE INVENTION

The following are definitions of terms used in this description and in the field to which the invention relates:

The term “offer” is used herein to denote one of a number of alternatives available for presentation to a potential respondent. An offer may include a presentation of information or a notice to a potential respondent. Examples of offers include but are not limited to offers for sale of a product or service, or offers ancillary to an offer for sale such as a “buy one get one free” promotion or special price.

“Respondent”, or potential respondent usually refers to a person or individual who is expected to respond to an offer. An example of a respondent is a potential customer for a product or service that is being promoted via an offer.

“Responses” can be in various forms and at various levels. Thus examples of responses include “clicks” on a link on a web page (A click may be for example the use of a mouse or other pointing device to choose or indicate an area or icon on a screen or monitor; clicks may be performed using other devices such as touchscreens.), purchase of a product or other acquisition, e.g., within a predetermined time period, and a yes (or no) answer to a question posed or sentence read by a call center operator. These are not limiting examples and others will be apparent to those skilled in the art. Sometimes the term “response” is used to denote a positive response, for example in situations where a negative response to an offer is possible. It should also be noted that responses can be Boolean (e.g., for a betting website, whether or not a bet was made), integer (e.g., number of bets made) or real (e.g., total value of bets made).

An offer is said to be “served” to a potential respondent. The serving of an offer may take the form of for example presentation of a web page, in which case it is commonly referred to as an “impression”. The serving of an offer may take the form of display in a part of a web page, for example designed to improve the sales of products or services being promoted via the web page. Other examples of serving of an offer include but are not limited to reading a piece of text (script) to a caller, playing a piece of music such as an advertising jingle and mailing a flyer or advertising material, e.g., in paper form. A party serving an offer, or on whose behalf the offer is served, for example the party whose products or services are being promoted, may have available to it a number of different offers available to be served to a respondent, the selection of which may be according to one or more characteristics of the respondent.

“Response rate” is usually measured as ratio of responses to serves of a particular offer, but can also be measured in terms of number of responses in a unit time period, for example if the rate of serve is relatively stable. Number of serves and time period can be considered to be equivalent, or proportional for a constant rate of serves. Response rate can also be determined as a ratio of positive responses to serves, where negative responses are possible, or a ratio of positive responses to a total of non-responses plus negative responses.

In a computing system serving offers to respondents, responses are detected and may be reported e.g. in order to determine response rate. For this purpose response “events” may be defined, such as but not limited to a click on a web page, a text or voice answer “yes”, the expiry of a predetermined time period.

“Standard error” StdErr is a well-known statistical parameter and may be used for example as a measure of confidence in a calculation. Where several calculations are performed a standard deviation may be determined, with the standard error being related to the standard deviation StdDev by the equation: StdErr=Stdev/sqrt(n), where n represents the number of calculations used to determine the standard deviation. Thus the standard error decreases as sample size increases.

A “reward” is the hoped-for response to an offer. It may be as simple as a click on an item on a web-page, or it may be measured in monetary terms such as the profit derived from a customer making a purchase in response to an offer.

Rewards achieved in response to an offer may be distributed over a time period following the serving of an offer. A number of time-dependent functions may be used to represent the reward distribution and any of these is included in the term “reward distribution” unless otherwise stated. For example the reward distribution may be represented by an exponential decay function with the decay constant determined by the probability of having achieved a reward at a particular point in time. In another example the reward distribution may be a cumulative function for example the fraction of total expected reward received at any point in time. Alternatively the function may take on any other shape.

### SUMMARY

Some embodiments of the invention provide methods and systems using one or more processors in a computing system of selecting an offer from a set of offers to be served to one or more respondents. An embodiment of the method may include for example:
for each of the offers, obtaining an expected reward distribution including an estimate of the distribution over time of reward received in response to the offer;
receiving requests for a selection of an offer;
in response to each request making the selection of an offer wherein the selection depends at least partially on the expected reward distribution.

Thus in methods according to some embodiments of the invention, an estimate of the distribution is used instead of waiting for a set of real, or observed, data on which to base future reward predictions. For example the obtaining of each expected reward distribution may take place before the first serving of the corresponding offer. Thus reward distributions for each offer can be used before observational data has been gathered to determine the distribution.

According to some embodiments of the invention, the expected reward distributions are updated in repeated or iterative update operations after the initial serving of each offer. The updating may be based on an observed distribution of reward received in response to the servings of the offer. The updated expected reward distribution may then be used in the next selection of an offer.

The observed distribution does not need to span the whole of the period during which responses are expected. An update operation may be performed, according to some embodiments of the invention, at any time after the first serving of an offer. The observed distribution on which an update is based does not even need to include any positive responses.

Methods according to some embodiments of the invention may include compiling the observed reward distribution, for example for each offer. This may be performed for example by one or more processors in a computing system operating serve decision logic which may be said to be “observing” the distribution.

According to some embodiments of the invention confidence bounds may be maintained in association with the observed distribution so that any update is based on the observed distribution only to the limit of the confidence bounds. Thus the greater the set of observed responses, the greater will be the confidence in the observed distribution. This may help to mitigate the effect of random errors on the learning process.

The estimate of the reward distribution may be based on an estimate of the elapsed time, following the serving of an offer, by which most of the reward, e.g. 95%, will have been collected. For example if the time is 14 days, it is assumed that any respondent will have responded or otherwise generated a reward, by the end of 14 days after having been served that offer. According to embodiments of the invention, an update operation may take place before the expiry of this time following the first serving of an offer. For example, if the time period is 14 days, the expected reward distribution may be updated sooner than 14 days after the first serving of the offer. It may be considered that at this point in time a complete set of response data is not available. According to some embodiments of the invention updating may take place based on what may be termed “incomplete” response data. Nevertheless such updating may be beneficial and improve efficiency of offer selection. Other percentages and parameters may be used.

Some embodiments of the invention may take the form of a non-transitory computer readable medium storing or bearing instructions which, when executed or implemented in one or more processors in a computing system, cause the system to carry out any of the methods described herein.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a screen shot from a user interface via which an offer may be served to a respondent according to some embodiments of the invention;

FIG. 2 is a graph of hypothetical reward distribution according to some embodiments of the invention;

FIG. 3 shows an example of a series of operations that may be use according to some embodiments of the invention to learn a reward distribution resulting from an offer.

FIGS. 4A to 4D are graphs illustrating a process of learning a reward distribution according to some embodiments of the invention;

FIGS. 5A and 5B are schematic diagrams showing basic components of two alternative systems according to some embodiments of the invention;

FIG. 6 shows a screen shot such as might be shown to a user during system configuration according to some embodiments of the invention;

FIG. 7 is a schematic diagram showing components of a decision server according to some embodiments of the invention;

FIG. 8 is a schematic diagram showing components of an automated decision module according to some embodiments of the invention;

FIG. 9 is a graph showing the results of a simulation illustrating the benefit of some embodiments of the invention; and

FIG. 10 is a high level block diagram of an exemplary computing system according to some embodiments of the present invention.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

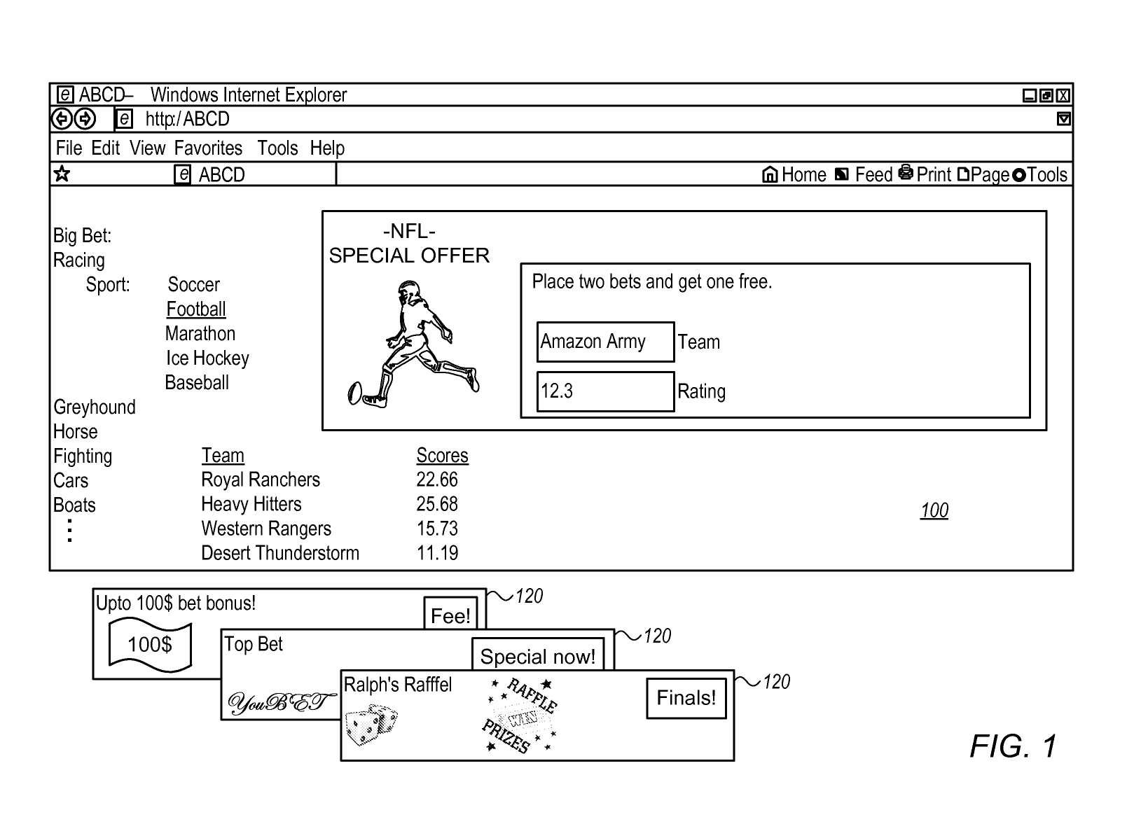

FIG. 1 shows a screen shot 100 from a user interface via which an offer may be served or provided to a respondent in a system according to some embodiments of the invention. A part of the screen 110 is made available for a selected offer to be presented. A set of possible offers 120 that may populate screen area 110 is shown on the right. Some embodiments of the invention relate to the manner in which one of the offers 120 is selected for serving.

An offer may be chosen on the basis of a prediction of the likely reward to result from the offer. A model of respondent behavior may be used to make the prediction. The model may be improved to better reflect actual respondent behavior based on actual response events. In other words the model may learn or be trained based on actual respondent behavior. The model may allow a computer system or a set of connected computer systems to provide better, or more accurate serving or providing of offers as compared to existing systems.

When a respondent is shown targeted content (offers, advertisements, or other information) there is often a delay before the respondent responds. This response may be needed for the system to evaluate the accuracy of the prediction made and hence improve its performance over time, for example by updating the model. This evaluation and improvement can only be made after the respondent has been given adequate time to respond. After that time, if no response has been generated or no reward received, this lack of response or reward or both, sometimes referred to as a negative response, may also be used in the evaluation of the system and/or model.

FIG. 1 shows an example of a betting website in which a system may target a particular offer, ancillary to betting, to an individual respondent. Such a system, and other systems according to embodiments of the present invention, may be in some embodiments be an automated system providing services to a large number of users, recipients, bettors and/or offer-makers, and a number of different models may be kept track of. The respondent may come back to the site several times before placing a bet. After an offer 120 is presented to the respondent, for proper performance evaluation the system should give the respondent enough time to act on that offer before determining whether they responded or not and then, for example, appropriately updating the model. This time could be several days. For more expensive purchases it could be several weeks.

This situation may be referred to as “Delayed Rewards”. The need to wait for the respondent to respond brings an unavoidable delay to the initial creation of a model and to subsequent learning in order to improve the model.

The modeling of delayed rewards may do for example:
Display offer to respondent
Wait predetermined time to collect any response from all potential respondents (could be days or possibly weeks)
Create model

The behavior of respondents of different types in response to different offers may be modeled. The result of such modeling is commonly described as a single model. The singular term “model” is used herein to denote a model of the behavior of a single respondent in response to a single offer as well as a collection of such models.

The model may be used on a subsequent occasion when a similar offer is created and may be updated to improve its accuracy by comparing a prediction with what actually happened. It will be appreciated that using this process the creation of a model for delayed rewards may be very slow. The consequent delay to learning may have tangible effects such as:
Models will be slow to respond to change
It takes a long time to show a return on investment (ROI) to client or potential client e.g. of a modeling system or method.
   The fastest that models can respond to change or show ROI to a client is the predetermined waiting time above.

Some embodiments of the invention provide methods and systems that allow learning and hence updating of a model to start immediately after an offer has been displayed to a respondent, thereby minimizing the delay to learning, and improving the operation and accuracy of the overall system. According to some embodiments of the invention this may be done by learning the reward distribution, e.g. over time.

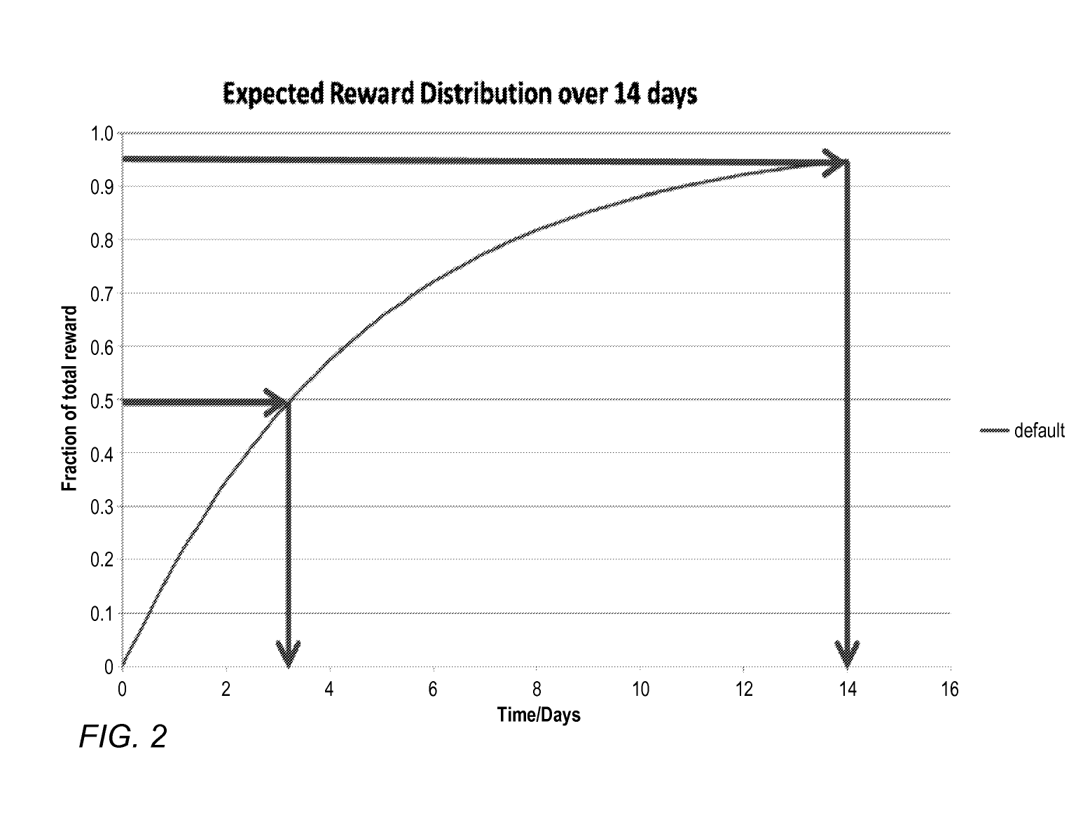

A hypothetical cumulative reward distribution which may be used in some embodiments of the invention may look like the graph of FIG. 2. This shows an expected reward distribution over 14 days for a hypothetical offer. For the respondents who are going to respond to the offer, this graph shows the probability of receiving a response by any particular time. In this example an exponential reward distribution function is assumed.

Thus, according to some embodiments of the invention, it may be assumed that that the probability of reward arriving by any particular time after the offer is shown follows a cumulative exponential decay function which may be represented by the equation of, for example:

p=1−ê(−αt), (1)

where:
t is time
α is a constant
p is the probability of a reward arriving by time t.

It may be further assumed that most rewards arrive quickly after which there is a long tail. In the example reward distribution shown in FIG. 2, there is a 50% probability that any response arrives within 3.25 days, rising to 95% within 14 days.

If this distribution is known, or approximated, e.g. for a group of respondents, or for a particular offer or set of offers, the model may be updated at any arbitrary time after the offer is shown to a respondent. For example, the distribution shown in FIG. 2 shows that it can be expected that after 3.25 days, on average, 50% of the original predicted reward would have already been received. If an original prediction was that after the offer was displayed the respondent would spend $100, then at 3.25 days, on average, it could be expected that $50 would have been received. If only $40 was received by that time the prediction was too high and the model can be adjusted accordingly. As with other examples shown herein, other parameters and percentages may be used.

It will be appreciated from the foregoing that it is not necessary to have received a reward in order to update the model, and therefore updates can be performed at any time and optionally but not necessarily in response to receiving a reward. An update can even be performed before a single reward has been received.

Some embodiments of the invention provide an efficient way to learn this distribution, or a more efficient way for a computer system to use such distribution information.

It should be noted that the time t in equation (1) is the time between the serving of an offer to a respondent and that respondent generating a reward. This may not correspond to the time elapsed from the initial serving of the offer since the same offer may be served to different respondents at different times.

According to some embodiments of the invention a different expected reward distribution is prepared for each offer. The expected reward distribution may be used in modeling respondent behavior. Having a different expected reward distribution for each offer is useful since the expected time within which most of the reward can be assumed to have been collected, sometimes known as the “drop-off” time, may vary markedly between one offer and another. For example, some offers may be more expensive than others and require more thought on the part of the respondent before responding. The more delayed the collection of the reward, the slower is the process of learning the reward distribution. This is particularly notable in learning methods which rely on waiting for reward to have been received before any updating of a model is carried out.

It may be desirable to minimize random errors which may occur between the different expected reward distributions, since small errors in the distributions can lead to large errors in the targeting of offers to respondents.

Simply creating one histogram for each offer of the delay between display of the offer and response, although possible according to embodiments of the invention, may lead to distributions containing random errors that will impede learning. It is desirable for each expected reward distribution to change slowly and only in the direction of greater accuracy.

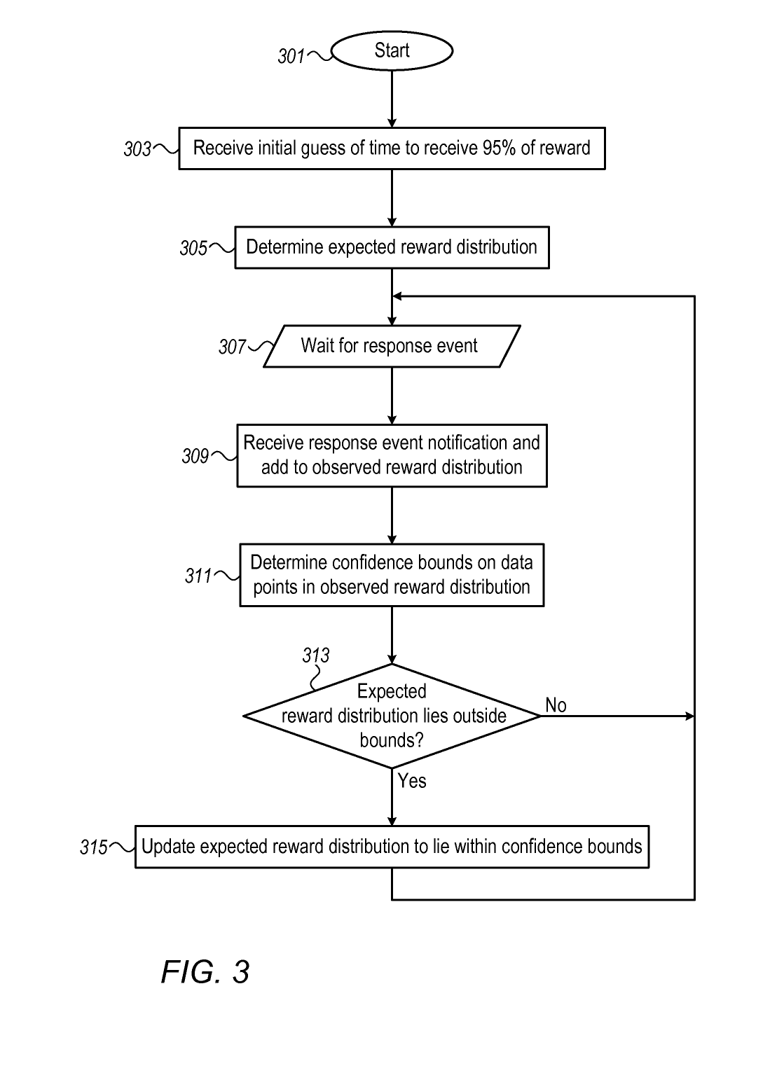

FIG. 3 shows an example of a series of operations that may be use according to some embodiments of the invention to learn a reward distribution resulting from an offer. The offer may be for example a buy one get one free offer on socks. The flow shown in FIG. 3 is for one offer. Distributions for other offers, e.g. T-shirts, may be learned in similar processes. If different offers such as socks, T-shirts and shorts, are made to different respondents over a time period, different learning processes such as that shown in FIG. 3 may operate in parallel. The operations shown in FIG. 3 may be performed on one or more processors in a computing system, an example of which is also described herein.

The flow of FIG. 3 begins with initialization at operation 301, following which in operations 303 and 305 an expected reward distribution is obtained, for example in terms of an exponential decay function, a cumulative exponential function of the kind shown in FIG. 2 or any other representation of the expected distribution of reward over time. For example the expected distribution of reward over time may show the total reward the system expects to receive for any elapsed time after the display of the offer. The amounts may be calculated periodically, for example daily or hourly, depending for example on the nature of the offer.

Operations 303 and 305 may be, but are not always required to be, carried out before, in other words prior to the first serving of the offer and may also be referred to as the initial approximation. According to embodiments of the invention one or more processors may retrieve the expected reward distribution from elsewhere, such as one or more external computing devices where the expected reward distribution is determined. Alternatively the expected distribution may be determined in one or more processors operating according to embodiments of this invention. The overall aim of the operations shown in FIG. 3 is to update the expected reward distribution so that it more closely represents an actual or observed reward distribution in order that predictions of reward made using this distribution will be more accurate.

The determination of the expected reward distribution according to the embodiment shown in FIG. 3 includes receiving in operation 303 an initial estimate of the drop off time, for example the time at which it can be assumed that most of the reward, for example a predetermined majority fraction such as 95%, will have been received (other majority fractions may be used). The initial estimate can be received from another computing device or can be input by an operator. It may be an arbitrary amount of time or it can be an educated guess, for example based on past experience.

From equation (1), knowing the drop off time a can be determined and then the initial guess may be used to determine an expected reward distribution. This may be done at operation 305 for example by fitting a cumulative exponential decay function to the time estimate received in operation 303, such as the function represented by equation (1). The reward distribution determined at operation 305 may also be regarded as a default reward distribution since it may be used by default in the determination of an expected reward even if there is no observed reward distribution on which to base a determination.

In a separate series of operations 307-311 that need not necessarily follow operations 303-305, an observed reward distribution is compiled. At 307 a processor implementing a method according to an embodiment of the invention is in a waiting state awaiting a response event. At operation 309 a notification of a response event is received and used to compile an observed reward distribution. The response event will have occurred in response to the serving of an offer. The notification may identify the offer and an amount of reward, e.g. income from a respondent. In some methods and systems according to embodiments of the invention, negative response events may be notified as well as positive response events. A negative response event could include but is not limited to a respondent positively declining an offer or no response having been received after a predetermined period of time such as the time period received in operation 303.

At operation 311 confidence bounds are maintained for data points, possibly but not necessarily all data points, included in the observed distribution. This will include the determination of the confidence bounds, e.g. upper and lower limits, for data points in a manner known in the art. For example the confidence bounds may be the observed amount plus or minus one standard error. As each new data point is added to the observed distribution the confidence bounds predetermined for existing data points will need to be determined anew, e.g. recalculated.

Operations 313 and 315 relate to the updating or adjusting of the expected reward distribution. According to some embodiments of the invention, these operations may be carried out in response to each response event. According to other embodiments of the invention the performance of these operations may be asynchronous with the receiving of response event notifications.

At operation 313 it is determined whether the expected reward distribution lies outside the confidence bounds and if so, at operation 315 the expected reward distribution is adjusted or updated so that the expected reward distribution is within the confidence bounds. According to some embodiments of the invention the amount of the adjustment at operation 313 is just sufficient, for example the minimum needed, to bring the expected reward distribution within the confidence bounds.

If it is determined at operation 313 that the expected reward distribution is not outside the confidence bounds, operation 315 does not occur. The flow may return to operation 307 so that decision 313 only occurs after a response event. Alternatively, if the updating of the expected reward distribution is asynchronous, operation 313 may simply be repeated at intervals, for example periodically.

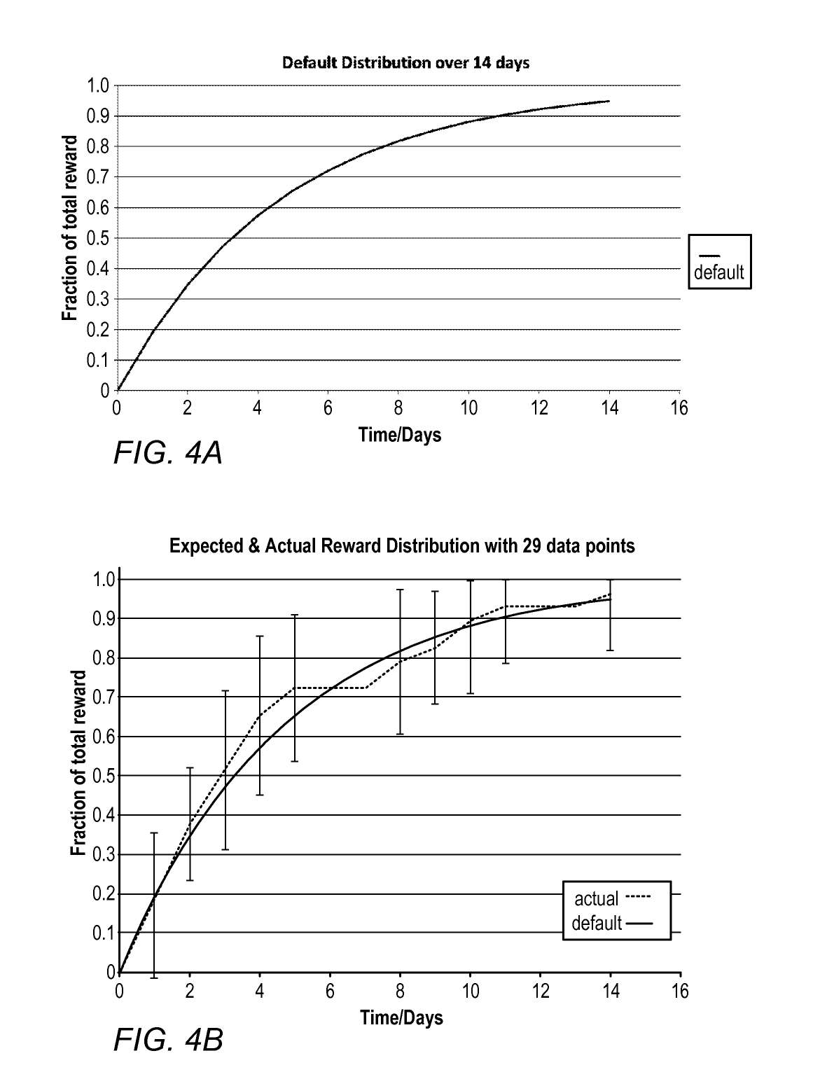

FIGS. 4A to 4D show the operations of FIG. 3 happening in a simulation. The initial guess for the time period used in operation 303 was 14 days, e.g. 95% of reward expected to have been received within this time period.

FIG. 4A shows the initial or default expected reward distribution that may for example be determined in operation 305.

FIG. 4B shows the default reward distribution together with a plot of 29 data points representing observed or actual reward. The actual distribution shown in FIG. 4B is the observed reward distribution compiled in successive iterations of operation 309. The vertical bars at each data point represent error bars or confidence bounds, such as may be determined at operation 311. The default reward distribution is within the confidence bounds at all data points. Therefore, following operations 313 and 315, no adjustments to the default expected reward distribution are made.

FIG. 4C shows a later stage in the operation of the flow of FIG. 3 in which 245 data points have been collected and plotted to form the observed reward distribution. Error bars are shown for only some of the data points but it will be seen that they are smaller than those in FIG. 4B indicating greater confidence that the data points are representative of expected reward rather than, for example, noise. At this stage part of the default distribution is not within the confidence bounds and the expected reward distribution, to be used in future reward predictions, is updated. The expected reward distribution is termed the “learned” distribution in the figure and the initial or default distribution, being the initial expected reward distribution, is also shown. It is the learned, or updated expected reward distribution that will be used in future predictions.

FIG. 4D shows a still later stage in the operation of the flow of FIG. 3 in which 2511 data points have been collected and plotted. Here it can be seen that the error bars are smaller still and the learned or updated expected reward distribution more closely follows the observed distribution.

FIGS. 4A to 4D show that it is possible to update the expected reward distribution at any arbitrary time after an offer has been served to a respondent. It is not necessary to wait for a predetermined time or for a predetermined number of responses to have been received.

In a practical implementation of the operation flow shown in FIG. 3, several similar flows will operate, for example in parallel, for example one for each of a set of offers that may be served to respondents.

Some embodiments of the invention may be used in making a decision between one or more offers to be served to a respondent. This may take the form of optimization of a web page for a particular respondent. Thus some embodiments of the invention may take the form of a system for web page optimization. Such a system may determine which is the most appropriate offer of a set of offers to be served to a respondent. It may be configured to implement the operations described with reference to FIG. 3.

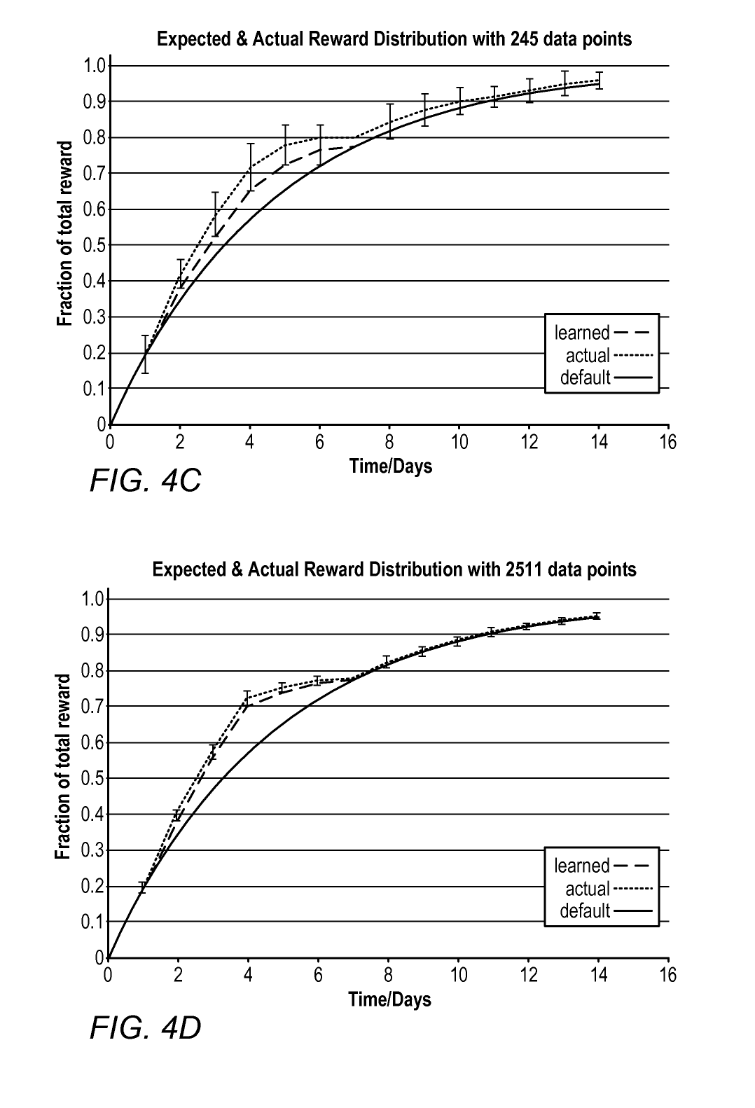

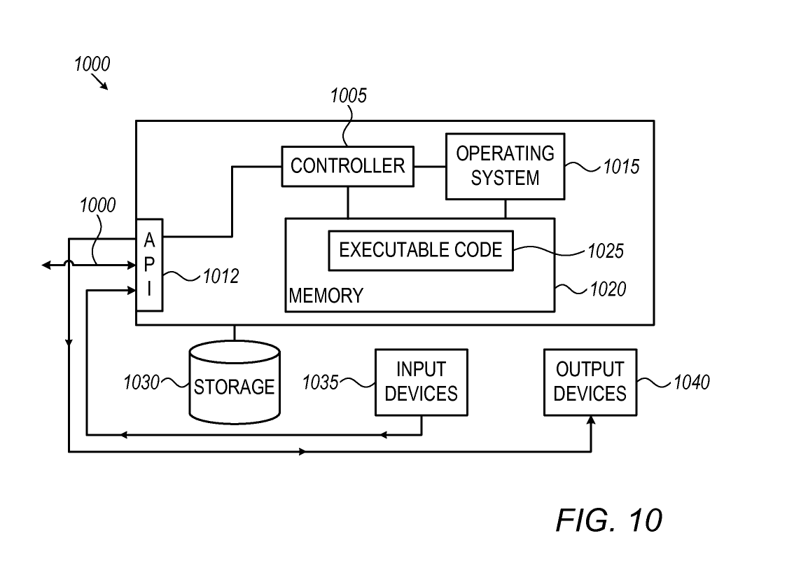

FIGS. 5A and 5B are schematic diagrams showing basic components of two alternative systems, according to some embodiments of the invention. Any of these components may include the computing system, or variations or parts of the computing system, shown in FIG. 10. Each of the systems shown in FIGS. 5A and 5B comprises a decision server 501, a website host server 502 and a respondent device 503 which in this example is shown as a personal computer, for example implementing a browser application. It should be noted that the servers 501 and 502 need not be physically separate or self-contained components. They could be virtual servers or services on shared servers. The components of the systems shown in FIGS. 5A and 5B may communicate with each other in any way including wired and wireless connections over one or more local, wide area or global networks. A user of the system such as the owner of the website may have access to the website host server 502, for example remote access via a user device 505 such as a personal computer, and may use this to perform tasks such as updating of information on a website. The same user may have access to the decision server 501. In other embodiments of the invention, the web host server 502 may be replaced by a call center server. In the case of a call center, the respondent device may be equipment used by the call center agent who records the response of the respondent during a telephone call. It should also be noted that a decision server such as server 501 may serve multiple web host servers or call centre servers or both, and therefore a system according to some embodiments of the invention may include one or more decision servers each serving one or more other servers. Also, a single user may require the services of more than one decision server, e.g., for a complex website it is possible that different parts may be served by different decision servers. Furthermore, according to some embodiments of the invention, the functions of any two or more of the system components shown in FIGS. 5A and 5B may be combined into one computing device or spread across more computing devices according to specific system requirements.

Each of the servers 501 and 502 and the respondent and user devices 503 and 505 may comprise computing devices comprising one or more processors. An example of a suitable computing device is illustrated in FIG. 10.

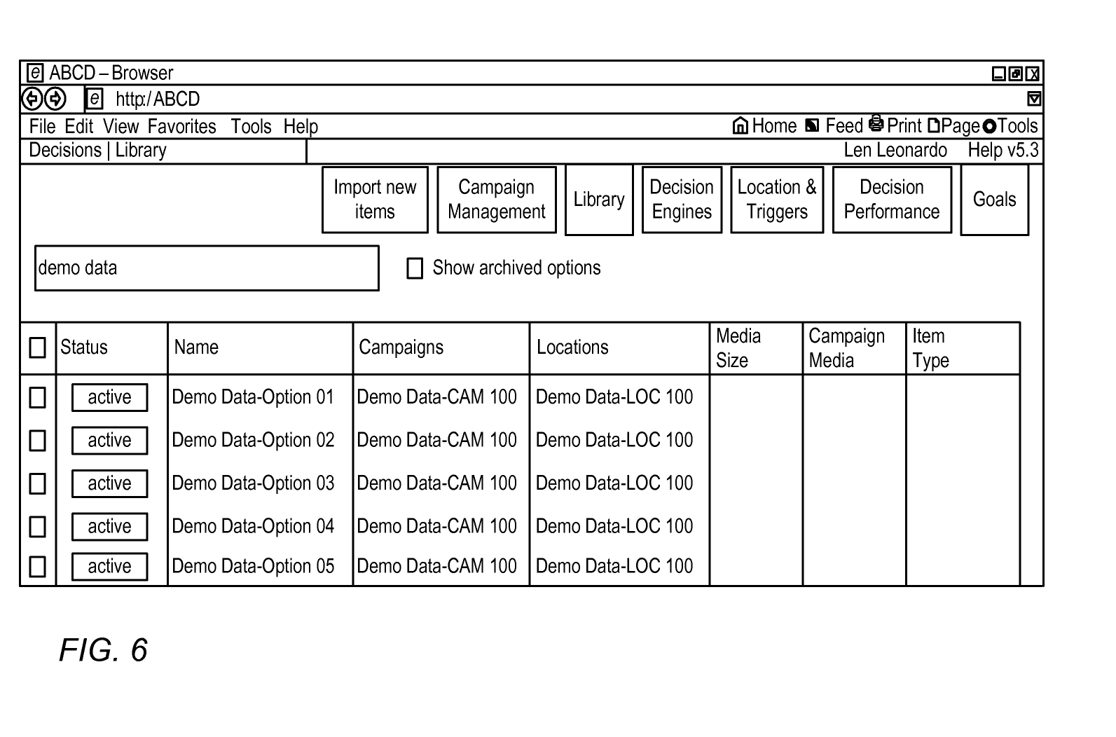

The decision server 501 may comprise one or more processors implementing one or more computing platforms or modules, two of which are indicated in FIGS. 5A and 5B, namely a data capture platform or module 508 that is described in more detail with reference to FIG. 7 and a configuration platform or module 509.

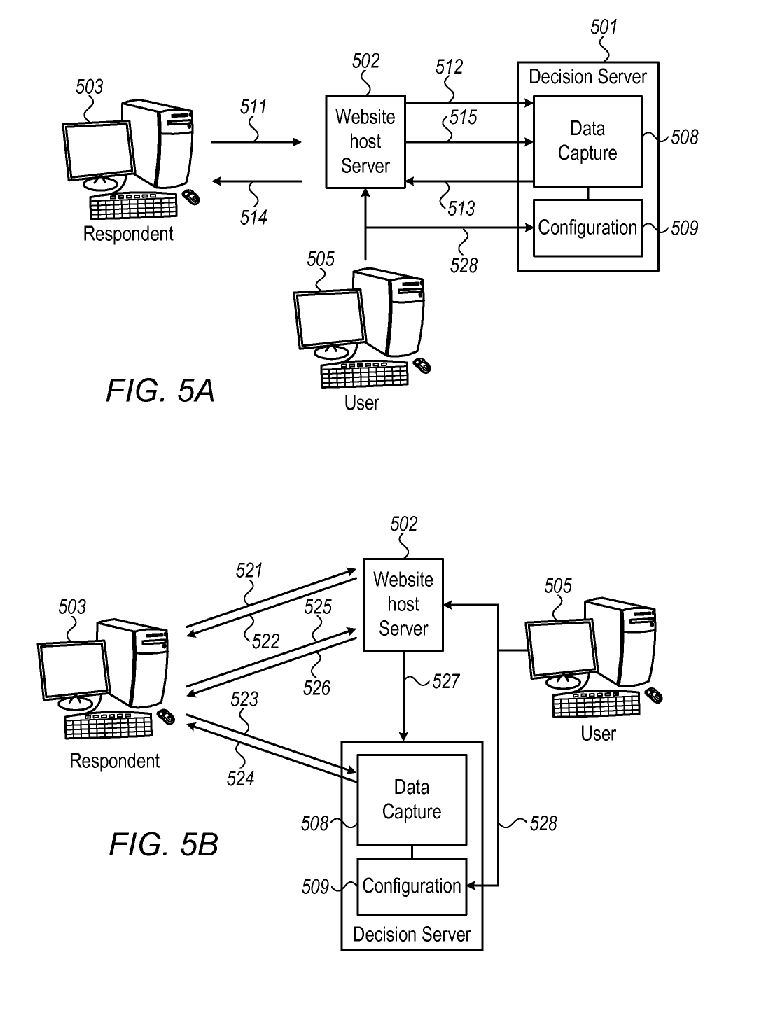

FIG. 6 is a screen shot such as might be presented to a user at user device 605 during the set-up or configuration of a product promotion, for example via a user interface “UI”. In the screenshot, a decisioning system configuration has been loaded by a user with five offers, and these offers have all been assigned to one location. A user may configure a system according to some embodiments of the invention using an application programming interface “API” running on user device 501 that communicates user input to configuration platform 509. In this example the configuration platform may determine aspects of the manner of operation of other parts, e.g. modules, of the decision server 501. An offer may be very simple and consist of a text string, or a more complex object such as an image, which will inform a calling application what to display to the respondent. The offer may be an HTML or JSON fragment, possibly containing a URL, pointing to an image. The location is the place where these offers are to be displayed. It may be an area of a web page, a desktop application in a call centre, a cashier's till at the point of sale in a retail store, or many other places.

A success criterion or goal may also be defined by a user so that the system can measure the success of each offer. The success criterion or goal may define the reward. This could be click through, product acquisition, revenue spent, or any other metric of interest. Whatever it is, whenever a respondent performs the behavior leading to the success criterion or goal, the decision server should receive this information to improve the accuracy of its predictions. The goal is determined by a user configuring the system.

For some embodiments of the invention, it is desirable to configure the estimated time period, or estimated drop off time, being the time period for which a system needs to wait to receive a predetermined majority fraction, for example an estimated 95% (or other suitable maximum percentage) of any response generated by the offer's display or other serving of an offer. In the examples of FIGS. 4A to 4D this is 14 days. In other examples, this may be set to 7 days e.g. for an e-commerce site for small to medium purchases. This configuration will generally be a guess and does not need to be accurate. It may be used as a starting point and the system will learn away from this if it is not accurate.

In the example systems shown in FIGS. 5A and 5B, configuration parameters such as success criterion and drop off time may be input by a user of device 505 and supplied to the configuration platform 509 along information path 528. Operations 303 and 305 of FIG. 3 may be implemented or performed in the configuration platform 509. The determined expected reward distribution may then be used to create a model for use in the selection of one offer or another. The model may be based of factors other than the expected reward distribution, such as respondent characteristics. The model may be created at the configuration platform 509 and supplied from the configuration platform 509 to the data capture platform 508. Alternatively the determined expected reward distribution may be supplied from the configuration platform 509 to the data capture platform 508 and the model may be created at the data capture platform. The model created using the determined expected reward distribution, for example in an iteration of operation 305, may be stored at the data capture platform, for example as part of a model stored in a model repository. It will be appreciated that operations may be allocated between the data capture module and the configuration module in a variety of ways and is not limited to these examples.

In the example of FIG. 6, the screen shot shows that five offers have been loaded to the decision server 601, denoted OPTION 01-OPTION 05, to be displayed at a location denoted LOC 100. It should be noted that these may be loaded to either server 601 or 602. During operation, the decision server 501 will receive requests for a decision as to which one of a set of offers is to be displayed. In other words the decision server is requested to select an offer for the next serve. The requests may come from a variety of sources depending on the nature of the offers. They may, for example, come from applications, running for example on respondent devices, referred to as calling applications. The offer may be very simple and comprise for example a text string instruction to a calling application, such as a universal resource locator “URL” pointing to an image.

FIGS. 5A and 5B are two system diagrams showing the interaction of a decision server with user and respondent devices according to embodiments of the invention. Two modes of operation are illustrated. In FIG. 5A, the request for an offer comes from the website content management system. In FIG. 5B, it comes from the browser during a page loading process.

Referring to FIG. 5A, possible information flows between the system components according to some embodiments of the invention may be as follows:
511—a browser application running or executing on the respondent device 503 requests a page from a website hosted by website host server 502
512—the website host server 502 sends a request to the decision server 501 for a decision as to which offer to serve, e.g. selection of an offer from a set of offers
513—in response to the request, the decision server 501 selects an offer and returns a decision to the website host server 502, this may be in the form of a URL identifying a web page, the selection may depend at least partially on the expected reward distribution, for example the most recently updated reward distribution or learned distribution such as shown in FIGS. 4C and 4D.
514—in response to receiving the decision, the website host server 502 returns the complete web page selected by the decision server 501 to the browser at the respondent device 503
515—response data is collected by the website host server and fed back to the decision server 501 for use in future decision making.
   It should be remembered that flows 513 and 515 may be asynchronous.

In the foregoing example, the content of each offer is stored at the website host server 502 and the decision server 503 simply uses identifiers for each offer. It is also possible, according to some embodiments of the invention, for the content to be stored at the decision server 501.

Referring to FIG. 5B, possible information flows between the system components is as follows, for an example where the offers comprise different variations of the same webpage:
521—a browser application running on the respondent device 503 requests a page from a website hosted by website host server 502
522—website host server 502 returns the page with an embedded tag identifying a variable part of the page
523—when the page renders the tag signals the browser at respondent device 503 to request the decision server for a decision as to which offer to serve
524—in response to the request, the decision server 501 selects an offer and returns an offer decision to the respondent device 503 This may be the actual content displayed or a reference to the actual content. The selection may depend at least partially on the expected reward distribution, for example the most recently updated reward distribution or learned distribution such as shown in FIGS. 4C and 4D.
525—if the respondent device 503 has received a reference to the actual content, it sends a request back to the website host server 502 for the content to display in the variable part of the page
526—in response to a request from the respondent device 503, the website host server 502 returns the content so that the complete page can be rendered by the browser on the respondent device 503
527—response data is collected by the website host server 502 and fed back to the decision server 501 for use in future decision making.

The response data is used to determine an actual reward. The determination of the actual reward resulting from the serving of an offer (or, for example if the reward is response rate, multiple serves of the offer) may be performed at the website host server 502, the decision server 501 or elsewhere. According to some embodiments of the invention, the reward is reported as a notification to a decisioning platform within the decision server 501.

It should be noted that, from the point of view of the respondent or other operator of respondent device 503, such as a call center agent, the communication between the website host server 502 and the decision server 501 is invisible, and the respondent or call center agent, for example, may not be aware that this is happening.

In brief, respondents have various offers displayed to them as they interact with some third party application. Whether or not they interact with this content (e.g., click through, go on to acquire something, or whatever the optimization goal is) this is recorded and notified to the decision server 501. A system according to some embodiments of the invention may learn that one offer is more successful than the rest in terms of reward for a particular group of respondents, and this offer will then be preferentially served to this group in future. Therefore, future respondents, or the same respondents coming back, should generate improved rewards. This invention aims to provide greater rewards from respondents more quickly and in a more reliable way.

A suitable architecture for a system according to some embodiments of the invention will now be described in more detail.

FIG. 7 is a diagram showing high level components that may be included in a decision server 501 according to embodiments of the invention. These include a decisioning platform 701 that operates within a data capture platform 702. Each platform 701, 702, includes software operating on one or more processors or hardware comprising one or more processors or a combination of hardware and software defining an operating environment in which other platforms or applications may operate. For example, the decisioning platform 701 according to some embodiments is a platform within which a plurality of different applications may operate, including an offer selection application. Thus, the decisioning platform 701 may be configured for many decision making scenarios other than offer selection which are not described herein. The platforms 702 and 703 may for example be implemented as executable code stored in memory 1020 of a computing system as shown in FIG. 10 to be executed by one or more processors, for example in controller 1005.

The decisioning platform 701 listens for requests for a selection of an offer from a set of offers, or Decision Requests. Decision Requests 705 may be received for example from a website host server such as server 502 or a respondent device such as device 503 as shown in FIG. 5. Decision Requests 705 may be received via an API-and may contain a location. This may be different from the location that is used in the configuration by a user and may for example be a geographical location. This location is referred to as the “context”. Decision Requests 705 are received by a request handler 706 which in the embodiment illustrated in FIG. 7 is part of the data capture platform 702. The request handler 706 may then use the context, if provided, to retrieve all eligible offers for that context. In the example of FIG. 7, according to some embodiments of the invention, the offers may be stored in an offer repository 703 which may be part of the data capture platform 702. Offer repository 703 may store only identifiers for multiple offers. These may be stored in sets, each set corresponding to a location as defined during configuration by a user. Thus, each set may comprise a plurality of alternative offers for a particular location. The retrieved offers are then supplied to an eligibility rules filter 707 which may be part of the decisioning platform 701. The retrieved offers may then be then filtered by eligibility rules. For example, there may be restrictions on what offers are available for users in different geographical locations (contexts). An example of such a restriction is a requirement not to display alcohol advertisements in certain US states.

According to some embodiments of the invention, the decision request 705 may include a value for one or more variables characterizing the respondent. These may be used to calculate a predicted reward for each offer and the prediction may be used in the selection of an offer to be served to the respondent. According to other embodiments of the invention, the decision request 705 may simply identify the respondent and values for variables characterizing the respondent may be retrieved from a database, for example at decision server 501.

A targeting strategy may then be applied to the set of filtered offers, for example using one or more targeting applications. This may be applied in a targeting strategy module 708 which is comprised in the decisioning platform 701. There are several available strategies and corresponding modules illustrated in FIG. 7 including rules, offline models, online learning and A/B testing. Each module may run a specific application. According to some embodiments of the invention, a set of offers, which may be filtered, is received and one of these is selected to be served using one or more of the applications. Once a selection has been made, e.g., an offer has been chosen, a decision 710 such as an offer or an identification of an offer may output, for example from the data capture platform 702. The decision 710 may be in the form of a signal identifying the selected offer to cause the selected offer to be presented to a respondent. The chosen offer may then be returned, for example to a calling application running on a respondent device 703, either directly or via a website host server for example according to the flows of FIGS. 5A or 5B. The offer may then be displayed or otherwise presented to the respondent.

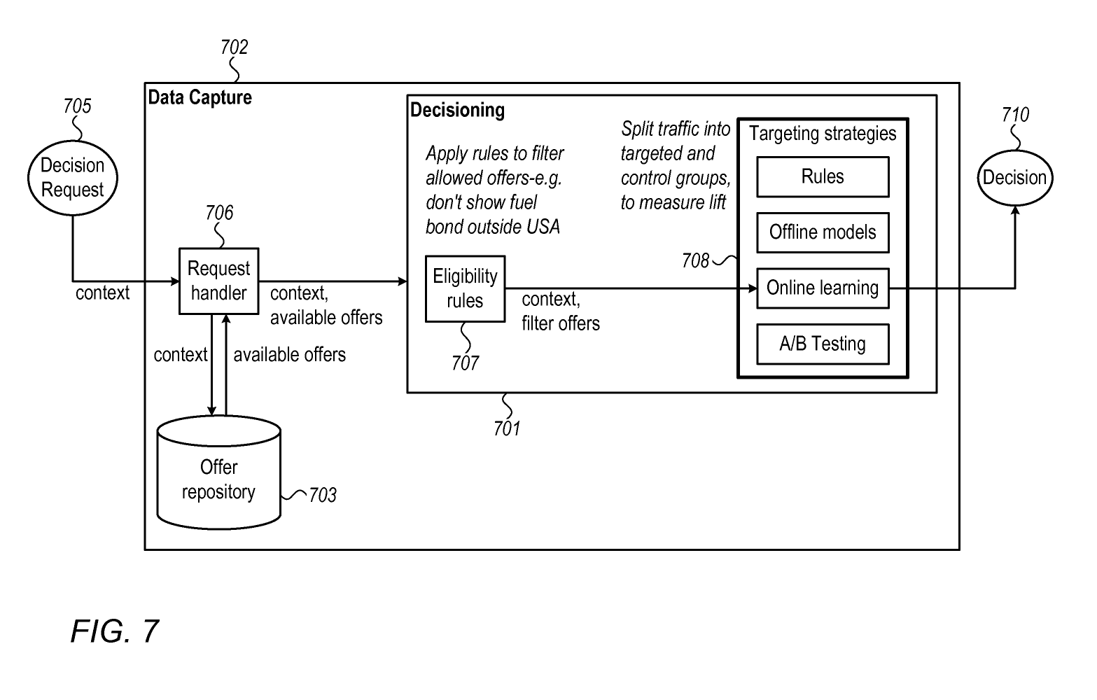

FIG. 8 schematically illustrates an online learning module 801 which may form part of the targeting strategy module 708. The online learning module receives a request for a selection of an offer from a set of offers, e.g., a decision request 805, which may be the decision request 705 of FIG. 7 after filtering using eligibility rules 707. The request 805 may comprise a set of offers and values for one or more variables characterizing the respondent, for example in a respondent profile, more usually referred to as a customer profile. The values for the variables may have been supplied as part of the request 705 or they may have been retrieved from the website host server 502 or the decision server 501 or elsewhere, depending on where the customer profiles or other respondent data is stored.

In response to the request, an offer is selected in decision module 807. The selection is based at least partially on the expected, e.g. learned, reward distribution. The selection may be carried out in various ways and may use the learned reward distribution in various ways. According to some embodiments of the invention, as part of the decision process, a predicted reward is calculated for each offer in the set of offers. The expected reward distribution may be used in the determination of predicted reward. For example, the predicted reward which is calculated may not be specific to the customer to whom the offer is served but may be a prediction of total reward, e.g. for all customers in a certain category over a particular period of time. This calculation may require knowledge of the drop-off time, so the sooner this can be learned based on observations, the earlier will improvements in calculation of total reward be achieved.

The decision, or selection of an offer, may be based solely on the predicted reward or may take other factors into account. Thus a score may be determined for each offer in response to the request and the score may simply be equivalent to the predicted reward or may take other factors into account. For example, according to some embodiments of the invention, all of the offers comprised in the request 805 may be scored against values for one or more variables characterizing the respondent, for example variables contained in a respondent profile, where each score is a prediction of the expected future reward from that particular offer being shown to the current respondent. The expected reward distribution may affect some of the variables, or the extent to which those variables are taken into account, or weighted, in the score determination. The scores may be generated using a mathematical model that is being continually updated, part of which may be the expected reward distribution. The expected reward distribution may be updated for example using the process described with reference to FIG. 3.

Following the decision, an “impression”, e.g., an instance of serving the offer, is logged in a serve logger 809 for the chosen offer. A signal identifying the selected offer is output to cause the selected offer to be served to a respondent. This is shown in FIG. 8 as the decision 811 being returned in response to the request.

Independently, positive response events, such as response event 820, may be received by a model repository 813 in which the model used to predict rewards is stored. These response events may come from many places and may depend on the goal and the configuration. Some examples:

If the goal is click-through on a web page, the click-through page could be tagged to automatically send an event to a decision server 501, in much the same way as packages like Google Analytics record page-views in real-time.

If the goal is revenue, a client of the decision server 501 (e.g., the company running the website) may send a batch of events every night created from their purchase records.

In the example embodiment of the invention shown in FIG. 8, the receiving of responses, for example as notifications in iterations of operation 309, results in an Update Model routine being performed in update model module 817. This may be preceded by an Update reward distribution routine being performed in an update reward distribution module 815. According to embodiments of the invention, the updating of the reward distribution or the model or both need not be synchronous with the receipt of response notifications and may even take place before a response notification has been received. However, in order for the updating to take place, the responses may be matched against any relevant offer impressions logged in serve logger 809.Thus according to some embodiments of the invention, some of the operations shown in FIG. 3 may be implemented in the update reward distribution module 815 shown in FIG. 8.

The updating can be considered to take place, in one example, in several stages:
In a first stage which may be implemented in update reward distribution module 815, response events are added to the observed reward distribution, for example according to operation 309 in FIG. 3, at this stage the confidence bounds for data points in the distribution may be determined according to operation 311.
In a second stage updates to the reward distribution are performed, for example according to operations 313 and 315, to generate an updated reward distribution.

The updated reward distribution generated in module 815 according to operations 313 and 315 may be provided to the update model module 817 and here it may be used, for example along with other information supplied from other sources, to update the model, for example to update a part of an overall model to which the updated reward distribution relates.

The reward distribution is not necessarily updated in response to each response event. According to some embodiments of the invention, update operations may be performed in module 815 after a batch of response notifications has been received. Batches of notifications may be compiled on a time basis, for example periodically such as daily or hourly, or on a numerical basis so that each batch contains the same number of responses. The batches may be compiled in the model repository 813, in which case the reward distribution may be updated in module 815 in response to the receipt of a batch of responses or response notifications from model repository 813. Alternatively module 815 may include memory or storage and the batches may be compiled at module 815. Either way, the module 815 may be responsible for receiving notifications, for example in batches, of response events occurring in response to servings of offers and compiling the observed reward distribution for each offer using said notifications.

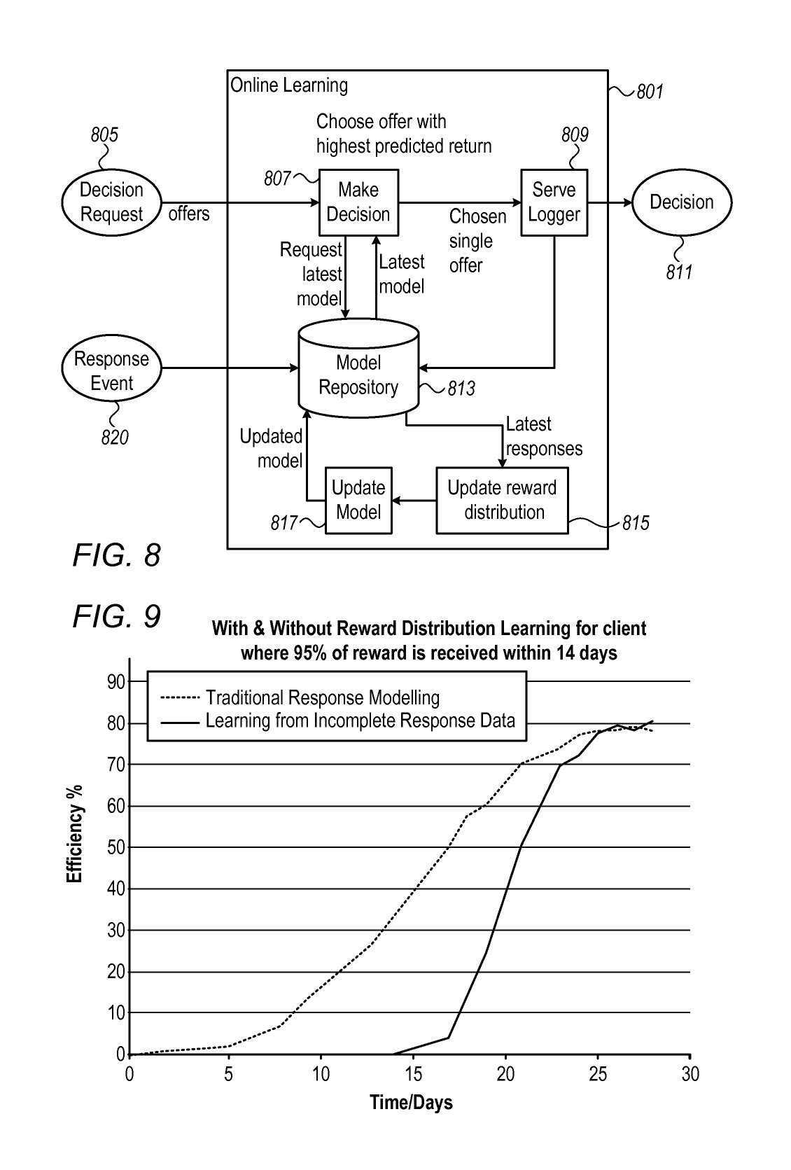

FIG. 9 is a graph showing efficiency against time comparing:
response modeling, or learning a reward distribution, in which the model is never updated before a period equal to drop-off time after each decision has been made i.e. the time for 95% of all responses to have been received, with
response modeling in which the model is updated according to some embodiments of the invention, without waiting a period equivalent to drop-off time before updates are performed.

The graph of FIG. 9 shows the results of a simulation where 10,000 customers visited a website over a period of 28 days. In the simulation there were three offers from which a selection was to be made and a system according to embodiments of the invention was to learn which offers to target to which customers. A response was defined to be a reward, so that a response was given a value of 1 and a lack of response by implication 0. In other words each customer had a binary response. The delay time for each response was randomly chosen from an exponential distribution, where 95% of the responses were received by day 14. The drop-off time was configured to 14 days.

The y-axis shows efficiency of learning. This defined so that if offers are chosen at random, efficiency equals 0%. If the best possible choice is made for every customer then efficiency equals 100%.

The lower line shows modeling according to a method known in the art. Here no learning happens for 14 days as no responses are processed during that time. The flat section shows that without learning the system can function no better than random. Once responses start to be processed, learning is rapid, reaching a plateau of about 80% after 26 days.

The upper line shows modeling according to a method according to some embodiments of the invention. Learning starts immediately. Even though the efficiency is low at the beginning the system will be giving a positive ROI from an earlier stage.

This is a very simple simulation where the drop-off time was guessed correctly and the default distribution was correct. It shows the benefit of using a reward distribution to perform updates. Some embodiments of the invention enable use of a reward distribution in a reliable way.

Reference is made to FIG. 10 showing a high level block diagram of an exemplary computing system 1000 according to some embodiments of the present invention, for example for use in systems according to embodiments of the invention. For example, decision server 501 or other computing devices carrying out all or part of some embodiments of the present invention may include components such as those included in computing system 1000. Computing system 1000 may comprise a single computing device or components, and functions of system 1000 may be distributed across multiple computing devices. Computing system 1000 may include one or more controllers such as controller 1005 that may be, for example, a central processing unit processor (CPU), a chip or any suitable processor or computing or computational device, an operating system 1015, a memory 1020, a storage 1030, input devices 1035 and an output devices 1040. For example, server 501 may include one or more controllers similar to controller 1005, server 501 may include one or more memory units similar to memory 1020, and server 501 may include one or more executable code segments similar to executable code 1025. One or more processors in one or more controllers such as controller 1005 may be configured to carry out methods according to some embodiments of the invention. For example, controller 1005 or one or more processors within controller 1005 may be connected to memory 1020 storing software or instructions that, when executed by the one or more processors, cause the one or more processors to carry out a method according to some embodiments of the present invention. Controller 1005 or a central processing unit within controller 1005 may be configured, for example, using instructions stored in memory 1020, to perform the operations shown in FIG. 3. The platforms 702 and 703 of FIG. 7 may be implemented as executable code stored in memory 1020 to be executed by one or more processors, for example in controller 1005.

Operating system 1015 may be or may include any code segment designed and/or configured to perform tasks involving coordination, scheduling, arbitration, supervising, controlling or otherwise managing operation of computing system 1000, for example, scheduling execution of programs. Operating system 1015 may be a commercial operating system. Memory 1020 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. In one embodiment, memory 1020 is a non-transitory processor-readable storage medium that stores instructions and the instructions are executed by controller 1005. Memory 1020 may be or may include a plurality of, possibly different memory units.

Executable code 1025 may be any executable code, e.g., an application, a program, a process, task or script. Executable code 1025 may be executed by controller 1005 possibly under control of operating system 1015. Executable code 1025 may comprise code for selecting an offer to be served and calculating reward predictions according to some embodiments of the invention.

In some embodiments, more than one computing system 1000 may be used. For example, a plurality of computing devices that include components similar to those included in computing system 1000 may be connected to a network and used as a system.

Storage 1030 may be or may include one or more storage components, for example, a hard disk drive, a Compact Disk (CD) drive, a CD-Recordable (CD-R) drive, a universal serial bus (USB) device or other suitable removable and/or fixed storage unit. For example, memory 1020 may be a non-volatile memory having the storage capacity of storage 1030. Accordingly, although shown as a separate component, storage 1030 may be embedded or included in memory 1020. Storage 1030 or memory 1020 may store identifiers of or content of offers, and may thus serve the function of offer repository 703 shown in FIG. 7. They may also be used to store impression and response data and may serve the function of server logger 809 shown in FIG. 8.

Input to and output from a computing system according to some embodiments of the invention may be via an API, such as API 1012 shown in FIG. 10. The API 1012 shown in FIG. 10 operates under the control of the controller 1005 executing instructions stored in memory 1020. Input to and output from the system via the API may be via input/output port 1013. Input may comprise decision requests 805, for example from respondent device 503 or website host server 501. Output may comprise an offer selection. This may be in the form of a signal that causes a selected offer to be presented to a respondent. The signal may identify the offer and it may also comprise the content of the offer, such as one or more of text, graphical information (including video) and audio information.

The decision server 501 may include user input devices. Input devices 1035 may be or may include a mouse, a keyboard, a touch screen or pad or any suitable input device. It will be recognized that any suitable number of input devices may be operatively connected to computing system 1000 as shown by block 1035.

The decision server may include one or more output devices. Output devices 1040 may include one or more displays, speakers and/or any other suitable output devices. It will be recognized that any suitable number of output devices may be operatively connected to computing system 1000 as shown by block 1040. Any applicable input/output (I/O) devices may be connected to computing system 1000 as shown by blocks 1035 and 1040. For example, a wired or wireless network interface card (NIC), a modem, printer or a universal serial bus (USB) device or external hard drive may be included in input devices 1035 and/or output devices 1040.

Input devices 1035 and output devices 1040 are shown as providing input to the system 1000 via the API 1012 for the purpose of embodiments of the invention. For the performance of other functions carried out by system 1000, input devices 1035 and output devices 1040 may provide input to or receive output from other parts of the system 1000.

Alternatively, all output from the decision server 501 may be to a remote device such as user device 505 in which case the output devices may be replaced by a data port.

Some embodiments of the invention may include computer readable medium or an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, some embodiments of the invention may comprise a storage medium such as memory 1020, computer-executable instructions such as executable code 1025 and a controller such as controller 1005.

A system according to some embodiments of the invention may include components such as, but not limited to, a plurality of central processing units (CPU), e.g., similar to controller 1005, or any other suitable multi-purpose or specific processors or controllers, a plurality of input units, a plurality of output units, a plurality of memory units, and a plurality of storage units. An embodiment of system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method, using one or more processors in a computing system, of selecting an offer from a set of offers to be served to one or more respondents, the method comprising:
for each of the offers, obtaining an expected reward distribution comprising an estimate of the distribution over time of reward received in response to the offer;
receiving requests for a selection of an offer;
in response to each request making the selection of an offer wherein the selection depends at least partially on the expected reward distribution;
updating the expected reward distributions in repeated update operations after the initial serving of each offer, the updating being based on an observed distribution of reward received in response to the servings of the offer; and
using the updated expected reward distribution in the next selection of an offer.

2. The method of claim 1 in which the obtaining of each expected reward distribution is performed prior to the first serving of the corresponding offer.

3. The method of claim 1 wherein obtaining an expected reward distribution comprises receiving an estimate of a time period within which a predetermined majority fraction of the reward will have been received and using the estimate of the time period to estimate said distribution over time of reward received in response to the offer.

4. The method of claim 3 wherein at least one of said updating operations is performed prior to the expiry of said time period.

5. The method of claim 3 wherein the determined expected reward distribution is an exponential function.

6. The method of claim 1 wherein at least the first update operation following the serving of an offer is performed prior to the receipt of any reward in response to the serving of the offer.

7. The method of claim 1 comprising receiving notifications of response events occurring in response to servings offers and compiling the observed reward distribution for each offer using said notifications.

8. The method of claim 7 wherein the updating of the expected reward distribution is asynchronous with the receiving of notifications.

9. The method of claim 7 comprising compiling the observed reward distribution for each offer using said notifications based on response events occurring in response to offers, wherein the compiling includes determining a confidence bound for data points in the observed reward distribution, and wherein the expected reward distribution is updated only to the extent that it lies outside the confidence bounds of the observed data points.

10. A method using one or more processors in a computing system of learning a distribution of reward received in response to an offer, the method comprising:
obtaining an expected reward distribution comprising an estimate of the distribution over time of reward received in response to the offer;
receiving notifications of response events occurring in response to servings of the offer and compiling an observed reward distribution for each offer using said notifications; and
updating the expected reward distributions in repeated update operations after the initial serving of each offer, the updating being based on an observed distribution of reward received in response to the servings of the offer.

11. The method of claim 10 wherein compiling the observed reward distribution includes determining a confidence bound for data points in the observed reward distribution, and wherein the updating of the expected reward distribution is limited to the extent that the expected reward distribution lies outside the confidence bounds of the observed data points.

12. The method of claim 10 wherein the obtaining of the expected reward distribution is performed prior to the first serving of the offer.

13. The method of claim 10 wherein the obtaining of the expected reward distribution comprises receiving an estimate of a time period within which a predetermined majority fraction of the reward will have been received and using the estimate of the time period to estimate said distribution over time of reward received in response to the offer.

14. The method of claim 13 wherein at least one of said updating operations is performed prior to the expiry of said time period.

15. A computing system comprising:
a memory; and
one or more processors for implementing a method of selecting an offer from a set of offers to be served to one or more respondents; wherein the one or more processors are configured to:
for each of the offers, obtain an expected reward distribution comprising an estimate of the distribution over time of reward received in response to the offer;
receive requests for a selection of an offer;
in response to each request make the selection of an offer wherein the selection depends at least partially on the expected reward distribution;
update the expected reward distributions in repeated update operations after the initial serving of each offer, the updating being based on an observed distribution of reward received in response to the servings of the offer; and
use the updated expected reward distribution in the next selection of an offer.

16. The system of claim 15 wherein the one or more processors are configured to implement a configuration module, the configuration module being configured to:
receive an estimate of a time period within which a predetermined majority fraction of the reward will have been received and
use the estimate of the time period to estimate said distribution over time of reward received in response to the offer.

17. The system of claim 15 wherein the one or more processors are configured to implement a data capture module, the data capture module comprising:
a decision module configured to:
receive said requests for a selection of an offer and in response make said selection of an offer; and
use the updated expected reward distribution in the next selection of an offer.

18. The system of claim 17 wherein the data capture module further comprises an update module configured to perform said update operations to update the expected reward distributions.

19. The system of claim 18 wherein the update module is further configured to receive notifications of response events occurring in response to servings of offers and compile the observed reward distribution for each offer using said notifications.

20. The system of claim 18 wherein said memory is configured to store a mathematical model for use in the selection of an offer and wherein the data capture module comprises an update module configured to use the updated reward distribution to update the model.
